(19) United States
(12) Patent Application Publication
(10) Pub. No.: US 2026/0123642 A1
(43) Pub. Date: May 7, 2026

(54) PLANT-BASED COFFEE CREAMER

(71) Applicant: Flora Food Global Principal B.V., Amsterdam (NL)

(72) Inventors: Izabela GLADKOWSKA BALEWICZ, Amsterdam (NL); Eleni NTONE, Amsterdam (NL); Jaimy Chantal VON HARRAS, Amsterdam (NL)

(73) Assignee: Flora Food Global Principal B.V., AMSTERDAM (NL)

(21) Appl. No.: 19/376,614

(22) Filed: Oct. 31, 2025

(30) Foreign Application Priority Data
Nov. 6, 2024 (EP) 24211053.4

(51) Int. Cl. A23C 11/10; A23L 29/00; A23L 29/10; A23L 29/269

(52) U.S. Cl. CPC A23C 11/103; A23L 29/015; A23L 29/10; A23L 29/272

(57) ABSTRACT

The invention provides a plant-based coffee creamer comprising a vegetable oil, a plant-based protein, a polysorbate, potassium phosphate and a gum, wherein the gum is high acyl gellan gum or a combination of xanthan gum and locust bean gum. The plant-based coffee creamer according to the present invention has a surprisingly improved texture and stability.

### CROSS-REFERENCE TO RELATED APPLICATIONS

This application claims priority to EP patent application Ser. No. 24/211,053.4 filed on Nov. 6, 2024, the disclosures of which are hereby incorporated by reference in their entirety.

### FIELD OF THE INVENTION

The present invention relates to liquid coffee creamers as an alternative to dairy based coffee creamer, predominantly and preferably containing non-animal ingredients and methods to produce the same. More specifically, the present disclosure is directed to coffee creamers comprising potassium phosphate, polysorbate and high acyl gellan gum. Such coffee creamers can substitute dairy-based coffee creamers and provide excellent whitening, texture and mouthfeel when added to beverages such as coffee or tea.

### BACKGROUND OF THE INVENTION

a. A coffee creamer, also known as a coffee whitener, is a product commonly used to enhance the flavour, texture, and creaminess of coffee and tea. They are typically added to coffee to impart a milder taste and achieve a desired consistency.
b. Originally, coffee creamers were made from dairy ingredients like milk or cream. Creamers that do not contain lactose were subsequently developed. However, despite being labelled as non-dairy, many of these coffee creamers still contain dairy proteins such as casein or caseinate, which are derived from milk. For example, US2023147949 discloses a non-dairy coffee creamer comprising casein or caseinate. The presence of milk proteins enhances texture, creaminess, and stability so that some of the functional properties and sensory experiences associated with traditional dairy coffee creamers are maintained.
c. In recent years, there is a growing demand for products, including coffee creamers, comprising mostly non-animal and/or on-dairy ingredients. However, creating stable coffee creamers with only non-animal ingredients presents challenges.

One major challenge is obtaining a stable oil-in-water emulsion which does not separate during storage and when added in a hot, acidic application like coffee while also having the desired structure, texture, creaminess, and mouthfeel without using dairy ingredients. Vegetable oils are often added as an alternative for dairy fats and may improve the mouthfeel of plant-based coffee creamers. Texture and mouthfeel may also be improved by selection of particular plant-based proteins, such as pea protein and soybean protein.

Another major challenge is the provision of a stable emulsion in absence of dairy proteins that naturally contribute to stability in traditional coffee creamers.

When incorporating dairy milk or traditional coffee creamer into coffee, it usually blends smoothly, maintains stability in the solution, and imparts a whitening or creamy appearance. Existing plant-based alternatives often encounter a phenomenon known as feathering when added to beverages like coffee.

Feathering, also known as splitting, is characterized by the presence of particles resulting from protein coagulation or precipitation within the beverage. In coffee creamers, feathering can manifest as small particles or clumps forming in the coffee creamer when added to hot beverages like coffee or tea. This can lead to an unpleasant visual appearance and may also affect the texture or mouthfeel of the beverage. Feathering is typically caused by factors such as instability of proteins or emulsifiers in the coffee creamer, changes in temperature, or interactions with other ingredients in the beverage.

To reduce feathering in plant-based coffee creamers, emulsifiers and stabilizers are added.

US20200015491, for example, discloses a plant-based coffee creamer comprising water, sunflower oil, dipotassium phosphate, pea protein and various types of gum (xanthan gum, Tragacanth and/or gellan).

WO2017216194 describes a liquid coconut-based coffee creamer comprising coconut cream, sugar, dipotassium phosphate and high acyl gellan gum.

Another example of a plant-based coffee creamer comprising a combination of gums is “Nut-Pod dairy-free creamer” marketed by Nutpods. It contains water, coconut cream, almonds, acacia gum, gellan gum, sea salt, dipotassium phosphate and sunflower lecithin.

A disadvantage of using a combination of different gums is that they interact with each other in complex ways, potentially leading to unpredictable outcomes in terms of texture and stability. Achieving the desired balance between gums may therefore require extensive formulation optimization.

Another strategy to improve solubility and dispersibility of plant-based proteins and reducing the risk of feathering, is modifying the proteins through techniques like enzymatic hydrolysis or heat treatment. However, enzymatic hydrolysis of proteins may result in a bitter taste.

Achieving plant-based coffee creamers that dissolve quickly, impart excellent whitening capabilities, and maintain stability without experiencing feathering or sedimentation when incorporated into cold or hot beverages like coffee or tea, while delivering a superior taste and mouthfeel remains challenging.

### SUMMARY OF THE INVENTION

a. In a first aspect the invention pertains to a plant-based coffee creamer comprising a vegetable oil, a plant-based protein, a non-ionic emulsifier, a potassium phosphate and water.
b. In particular, the invention relates to a plant-based coffee creamer comprising water, 0.1 to 36 wt. % vegetable oil, 0.05 to 3 wt. % plant-based protein, 0.1 to 2.0 wt. % polysorbate, 0.05 to 1.0 wt. % potassium phosphate, and 0.01 to 0.5 wt. % gum, wherein the gum is high-acyl gellan gum and/or a combination of xanthan gum (XG) and locust bean gum (LBG), and wherein all wt. % values are based on the total weight of the coffee creamer.
c. Preferably, the polysorbate is polysorbate 60 or polysorbate 80, the potassium phosphate is dipotassium phosphate, and the sole gum is high-acyl gellan gum. Preferably, the coffee creamer comprises 0.01 to 0.1 wt. % gum, most preferably 0.01 to 0.05 wt. % gum.
d. It was surprisingly found that a coffee creamer according to the present invention has enhanced emulsion stability, an improved whitening effect, and improved mouthfeel compared to known plant-based coffee creamers not comprising the combination of polysorbate, potassium phosphate and gum. The coffee creamer according to the present invention is an oil-in-water emulsion that remains physically stable throughout shelf life, both in acidic hot beverages such as coffee and in cold applications.

It is believed that this improved performance results from a combination of 0.05 to 1.0 wt. % potassium phosphate, 0.1 to 2.0 wt. % polysorbate, and 0.01 to 0.5 wt. % gum, wherein the gum is high-acyl gellan gum and/or the combination of xanthan gum (XG) and locust bean gum (LBG). Preferably the 0.01 to 0.5 wt. % gum is high-acyl gellan gum, more preferably the gum is 0.01 to 0.1 wt. % high-acyl gellan gum, most preferably 0.01 to 0.05 wt. % high-acyl gellan gum. Without wishing to be bound by theory, this combination appears to provide an improved balance between oil-droplet size and continuous-phase viscosity, resulting in a texture with increased body and creaminess that more closely mimics dairy-based coffee creamers, while reducing off-notes typically associated with plant-based ingredients.

### DETAILED DESCRIPTION OF THE INVENTION

a. In a first aspect the invention provides a plant-based coffee creamer comprising a vegetable oil, a plant-based protein, a polysorbate, a potassium phosphate and high acyl gellan gum or a combination of xanthan gum and Locust Bean Gum (LBG).
b. In particular, the invention relates to a plant-based coffee creamer comprising water; 0.1 to 36 wt. % vegetable oil; 0.05 to 3 wt. % plant-based protein; 0.1 to 2.0 wt. % polysorbate; 0.05 to 1.0 wt. % potassium phosphate; and 0.01 to 0.05 wt. % gum, wherein the gum is high-acyl gellan gum and/or a combination of xanthan gum (XG) and locust bean gum (LBG); and wherein all wt. % values are based on the total weight of the coffee creamer.
c. The invention preferably provides a coffee creamer without milk ingredients, including milk-derived proteins, such as casein or caseinate. Furthermore, the plant-based coffee creamer does not contain any ingredients of animal origin and may qualify as vegan.
d. In this specification, weight percentage (wt. %) is calculated based on the total weight of the coffee creamer unless stated otherwise.
e. The plant-based coffee creamer of the invention provides several technical advantages over known plant-based coffee creamers, including a good dispersion in a hot beverage, such as coffee, no curdling/flocking, and an improved texture and whitening effect.
f. In one embodiment, the present plant-based coffee creamer comprises water, 0.1 to 36 wt. % vegetable oil; 0.05 to 3 wt. % plant-based protein; 0.1 to 2.0 wt. % polysorbate; 0.05 to 1.0 wt. % potassium phosphate; and 0.01 to 0.1 wt. % gum, wherein the gum is high-acyl gellan gum and/or a combination of xanthan gum (XG) and locust bean gum (LBG); and wherein all wt. % values are based on the total weight of the coffee creamer.
g. Preferably, the present plant-based coffee creamer comprises water, 0.5 to 20 wt. % vegetable oil, preferably canola oil; 0.05 to 3 wt. % plant-based protein, preferably pea protein, fava protein, or lentil protein; 0.2 to 0.8 wt. % polysorbate, preferably polysorbate 60 or polysorbate 80:0.1 to 0.3 wt. % potassium phosphate, preferably dipotassium phosphate (K₂HPO₄); and 0.01 to 0.1 wt. % high-acyl gellan gum, wherein wt. % is based on the total weight of the coffee creamer. The coffee creamer may comprise a total amount of 0.01 to 0.1 wt. % gum. More preferably, the coffee creamer comprises 0.01 to 0.05 wt. % high-acyl gellan gum as sole gum.
h. In some embodiments, the present plant-based coffee creamer comprises water, 7 to 15 wt. % vegetable oil, preferably canola oil; 0.1 to 0.7 wt. % plant-based protein, preferably pea protein, fava protein, or lentil protein; 0.2 to 0.8 wt. % polysorbate 60 and/or polysorbate 80, preferably polysorbate 60:0.1 to 0.3 wt. % potassium phosphate, preferably dipotassium phosphate (K₂HPO₄); and 0.01 to 0.05 wt. % high-acyl gellan gum as the sole gum, wherein wt. % is based on the total weight of the coffee creamer.
i. A coffee creamer according to the present invention may further comprise 0.1 to 0.5 wt. % sodium chloride and/or 0.1 to 40 wt. % sugar. The coffee creamer does not comprise (added) mono- and diacylglycerides.
j. Alternatively, the coffee creamer according to the present invention may comprise a combination of xanthan gum and locust bean gum (XG/LBG) instead of high-acyl gellan gum.

### Vegetable Oil

a. The term “oil” or “liquid oil” is typically used for triglyceride compositions that that are liquid at room temperature. The term “liquid oil” is used for triglycerides that are liquid at room temperature, preferably also liquid at temperature below room temperature such as below 15, 10 or 5° C. Preferably the solid fat content of the liquid oil is 0 at 20° C., more preferably it is 0 at 15° C.
b. The coffee creamer comprises a vegetable oil. The vegetable oil may be selected from the group consisting of coconut oil, rapeseed oil, sunflower oil, linseed oil, soybean oil, maize oil, and canola oil. There is a preference for canola oil. The amount of vegetable oil is preferably 0.1 to 36 wt. % vegetable oil; more preferably 0.5 to 20 wt. %, most preferably 7 to 15 wt. % with wt. % calculated based on the total weight of the coffee creamer including water.

### Plant-Based Protein

a. The plant-based coffee creamer of the invention comprises a plant-based protein. The plant-based protein is preferably a vegetable protein. The plant-based protein may be selected from the group consisting of pea protein, fava (Vicia faba) protein, amaranth protein, chickpea protein, lima bean protein, and lentil protein; and any other suitable vegetable protein; or combinations thereof. Preferably, the plant-based protein is lentil protein or pea protein. The presence of a plant-based protein may contribute to the texture and mouthfeel of the coffee creamer and may improve the stability of the coffee creamer.
b. Preferably, the plant-based protein is present in an amount from 0.05 to 3 wt. %; more preferably 0.1 to 0.7 wt. % plant-based protein, most preferably 0.2 to 0.7 wt. %, with wt. % calculated based on the total weight of the coffee creamer including water.
c. In preferred embodiments, the protein (concentrate) does not include any or substantially any soybean protein to minimize allergenic reactions.

### Polysorbate

a. The plant-based coffee creamer of the invention comprises a polysorbate. Preferably, the polysorbate is selected from the group consisting of polysorbate 40, polysorbate 60, polysorbate 61, polysorbate 65, polysorbate 80, polysorbate 85; or a combination thereof. More preferably, the polysorbate is selected from the group consisting of polysorbate 40, polysorbate 60 and polysorbate 80; or a combination thereof. Even more preferably, the polysorbate is polysorbate 60 or polysorbate 80; or a combination thereof. Most preferably, the polysorbate of the plant-based coffee creamer of the invention is polysorbate 60.
b. The plant-based coffee creamer of the invention preferably comprises between 0.1 to 2.0 wt. % polysorbate; more preferably 0.5 to 1.0 wt. %, most preferably 0.2 to 0.8 wt. % with wt. % calculated on the total weight of the coffee creamer including water.

### Potassium Phosphate

a. The plant-based coffee creamer of the invention comprises potassium phosphate. The potassium phosphate may be monopotassium phosphate, dipotassium phosphate or tripotassium phosphate. Preferably, the potassium phosphate is dipotassium phosphate.
b. In one embodiment, the plant-based coffee creamer comprises a potassium phosphate. There is a preference for dipotassium phosphate, also known as potassium phosphate dibasic.
c. The plant-based coffee creamer may comprise 0.05 to 1.0 wt. % of the potassium phosphate, preferably 0.1 to 0.3 wt. %, with wt. % calculated on the total weight of the coffee creamer.
d. The inventors surprisingly found that a plant-based coffee creamer comprising potassium phosphate, in particular dipotassium phosphate, and a polysorbate, in particular polysorbate 60, appeared to have an improved emulsion stability compared to an otherwise identical coffee creamer in which potassium phosphate was substituted with sodium phosphate. The mechanism behind this effect is not understood but it appears that the potassium phosphate may interact with the polysorbate and/or high-acyl gellan gum, thereby enhancing the emulsion stability of the coffee creamer.

### Gum

a. The plant-based coffee creamer of the invention comprises a gum, wherein the gum is high acyl gellan gum and/or a combination of xanthan gum and Locust Bean Gum (LBG).
b. In a preferred embodiment, the present plant-based coffee creamer comprises high acyl gellan. The term high acyl gellan gum is a general term used in the field. High acyl gellan gum is typically a polysaccharide produced by the bacterium Sphingomonas elodea. Gellan gum is typically a straight chain polymer comprising a repeating unit, wherein the repeating unit is a tetrasaccharide of two residues of β-1,4-D-glucose (D-Glc), one residue of L-rhamnose (L-Rha) and one residue β-1,4-D-glucuronic acid (D-GlcA). The tetrasaccharide repeat may have the following structure: [D-Glc (β1-+4) D-GlcA (β1→4) D-Glc (β1→4) L-Rha (α1→3)]n. In contrast to low acyl gellan gum, high acyl gellan gum has a higher degree of acylation, meaning it has a greater number of acyl groups attached to the sugar backbone of the polymer. In high acyl gellan gum, acetate and glycerate substituents may be present on one of the glucose residues in the tetrasaccharide repeating unit. High acyl gellan gum typically has an average of one acyl group on each repeating unit of the tetrasaccharide. These acyl groups are acetyl and glyceryl groups, typically attached to the 6th carbon atom of one glucose residue and the 2nd carbon atom of the other glucose residue. Preferably, high acyl gellan gum is a gellan gum in which each tetrasaccharide repeating unit comprises on average (at least) one acyl group. Due to the presence of the acyl group, high acyl gellan gum may form a gel that is soft, elastic, and has strong adhesion.
c. Low acyl gellan gum is typically obtained through heat treatment in an alkaline environment (pH >10), which partially or completely removes the acyl groups from the polymer structure. Low acyl gellan gum is also referred to as de-acylated gellan gum.
d. In one embodiment, the present plant-based coffee creamer (further) comprises Xanthan gum and locust bean gum (XG/LBG).
e. In one embodiment, the present coffee creamer comprises 0.005 wt. % to 0.1 wt. % gum, preferably 0.01 wt. % to 0.05 wt. %, more preferably 0.02 wt. % to 0.04 wt. %, with wt. % calculated on the total weight of the coffee creamer. The gum is high acyl gellan gum and/or a combination of xanthan gum and Locust Bean Gum (LBG). Preferably, the gum is high acyl gellan gum as the sole gum. Preferably, the coffee creamer has a viscosity of between 1 to 500 mPa·s. at 7° C. as measured using a Brookfield viscometer, Spindle #2, at 60 rpm.
f. The inventors found that the use of high-acyl gellan gum and/or a combination of xanthan gum (XG) and locust bean gum (LBG) in a plant-based coffee creamer comprising a potassium phosphate, preferably dipotassium phosphate, and a polysorbate, preferably polysorbate 60, results in a plant-based coffee creamer having improved emulsion stability compared to formulations containing other gums, like guar gum, pectin, alginate, or low-acyl gellan gum, even when significantly lower amounts of gum are used in the present coffee creamer. In particular, plant-based coffee creamers comprising 0.01 to 0.05 wt. % high-acyl gellan gum in combination with polysorbate and potassium phosphate appeared to exhibit improved properties, including an enhanced whitening effect, and are therefore preferred.

In one embodiment, the plant-based coffee creamer of the present invention comprises a total amount of 0.01 to 0.5 wt. % gum, preferably a total amount of 0.01 to 0.1 wt. % gum, more preferably 0.01 to 0.05 wt. % gum, wherein wt. % is based on the total weight of the coffee creamer. Preferably, the coffee creamer comprises 0.01 to 0.05 wt. % high acyl gellan gum, more preferably 0.02 to 0.04 wt. % high acyl gellan gum. In some embodiments, the coffee creamer may comprise a combination of xanthan gum (XG) and Locust Bean Gum (LBG).

### Water

a. The plant-based coffee creamer according to present invention comprises water. The product may comprise an amount of water to bring the total balance of ingredients (oil, protein, and others) up to 100 wt. %.
b. Preferably the pH of the water-phase is 7.0 to 8.0. The pH of the plant-based coffee creamer of the invention can be adjusted based on the desired pH range by varying the concentration of the phosphate buffer and the ratio of its acidic and basic components. The pH can be adjusted for example by addition of an edible acid. Suitable acids include lactic acid, citric acid, hydrochloric acid. The preferred acid is citric acid.

### Other Ingredients

a. The plant-based coffee creamer of the invention may further comprise a stabiliser, a thickener, a flavouring agent, and/or a salt.
b. Flavoring agents can be added to the coffee creamer of the invention. Flavoring agents may include vanilla extract, chocolate flavoring, caramel flavoring, hazelnut or almond extract. These flavoring agents can be used individually or in combination to create various flavored coffee creamers to suit different preferences and seasonal trends.
c. Plant-based coffee creamers of the invention may further comprise salt. Salt, chemically known as sodium chloride (NaCl), is a multifunctional ingredient in coffee creamers, contributing to flavor enhancement, preservation, and texture modification. A coffee creamer of the invention may contain 0.01 to 1%, preferably 0.1 to 0.5 wt. % sodium chloride by total weight of the coffee creamer including water. Such an amount of salt may enhance the overall flavor profile of the coffee creamer.
d. In one embodiment, the coffee creamer according to the invention comprises a sweetener. A sweetener is a compound that provides sweetness to a product. Sweetness may be determined using sensory evaluation, e.g., human taste panels. The sweetener is preferably a sugar and/or a sugar substitute, e.g., stevia, monk fruit sweetener. Examples of suitable sugars include sucrose, glucose and fructose, sorbitol, maltitol, or erythritol. Alternatively, artificial or non-natural sweeteners may be used. Preferably the coffee creamer comprises at least 5 wt. % sugar with wt. % calculated on the total weight of the coffee creamer, more preferably at least 10 wt. %.
e. In one embodiment, coffee creamers according to the present invention comprise 1-30 wt. % sugar, wt. % calculated on the total weight of the coffee creamer, preferably 5-25 wt. % sugar. Adding sugar to the coffee creamer provided a coffee creamer with a higher viscosity and an improved texture. Such coffee creamers may further comprise a sugar substitute, preferably stevia.

### Processes

a. The invention further pertains to a method for making a plant-protein based coffee creamer according to any embodiment of the present disclosure comprising the steps of providing an aqueous phase
providing solid ingredients, including the plant-based protein, the potassium phosphate and the gum and, optionally, sugar and/or salts;
blending the protein, gum and potassium phosphate in the aqueous phase
providing an oil phase
providing polysorbate
blending the polysorbate with the oil phase
blending the oil phase and the aqueous phase to provide the coffee creamer.
a. The coffee creamer may be subjected to pasteurization or ultra-high-temperature (UHT) treatment. The method may further include a step of adjusting the pH to 7 to 8 using a food-grade acid, for example citric acid.
b. In one embodiment, the aqueous phase is at a temperature above 70 degrees Celsius, more preferably above 75 degrees Celsius and most preferably above 80 degrees Celsius when the gum is added.
c. In a preferred embodiment, the gum added is high acyl gellan gum and the aqueous phase is at a temperature above 70, more preferably above 75 and most preferably above 80 degrees Celsius when the high acyl gellan gum. The resulting coffee creamer was shown to have increased stability.
d. In alternative embodiments, the gum comprises a combination of xanthan gum and locust bean gum (XG/LBG) hydrated under the same conditions.

### EXAMPLES

### Water Droplet Size Distribution of Spreads (D3,3 Measurement)

The normal terminology for Nuclear Magnetic Resonance (NMR) is used throughout this method. On the basis of this method, the parameters D3,3 and exp (o) of a lognormal water droplet size distribution can be determined. The D3,3 is the volume weighted mean droplet diameter and o is the standard deviation of the logarithm of the droplet diameter. A D3,3<2 μm is acceptable for a coffee creamer, but a D3,3<1.5 μm is preferred. A preferred droplet size is about 1.3-1.5 μm. A e-sigma of <3 is desired.

The NMR signal (echo height) of the protons of the water in a water-in-oil emulsion are measured using a sequence of 4 radio frequency pulses in the presence (echo height E) and absence (echo height E*) of two magnetic field gradient pulses as a function of the gradient power. The oil protons are suppressed in the first part of the sequence by a relaxation filter. The ratio (R=E/E*) reflects the extent of restriction of the translational mobility of the water molecules in the water droplets and thereby is a measure of the water droplet size. By a mathematical procedure—which uses the log-normal droplet size distribution—the parameters of the water droplet size distribution D3,3 (volume weighed geometric mean diameter) and o (distribution width) are calculated. A Bruker magnet with a field of 0.47 Tesla (20 MHz proton frequency) with an air gap of 25 mm is used (NMR Spectrometer Bruker Minispec MQ20 Grad, ex Bruker Optik GmbH.DE).

### Whitening Effect

The whitening effect of is determined by measuring a, b, and L-values on conventional colorimetric equipment, such as a Hunterlab colorimeter. Improved whitening is indicated by a lower a and b value and an higher L-value compared to a reference, as well as based on visual inspection of a sample.

### Viscosity Measurement

The viscosity was measured using a Brookfield viscometer. Spindle #2 was inserted into the aqueous phase until the fluid level reached the immersion groove on the spindle shaft. The spindle was then attached to the lower shaft of the viscometer, and the viscosity was recorded at 7° C., with the viscometer operating at 60 rpm. A higher viscosity indicating a thicker, creamier texture.

### Texture

Texture was determined through sensory evaluation by assessing the mouthfeel and creaminess of the coffee creamer when added to hot coffee.

### Off Notes

Off notes were determined through sensory evaluation by assessing undesirable flavours or aromas, such as bitterness, beany, grassy, or metallic notes. A coffee creamer may be evaluated its own and when added to hot coffee to identify any off notes and their intensity.

### Stability

### Acid Hot Stability

To measure acid hot stability of a coffee creamer, an acidic coffee solution (pH 4.5-5.5) was prepared and heated to 85° C.-90° C. The coffee creamer (20% by volume) was added, stirred gently, and visually inspected for signs of destabilization, such as curdling or phase separation, over a period of 5-60 minutes. A stable coffee creamer will remain homogeneously mixed without visible separation, while an unstable coffee creamer will show flocculation.

### Shelf Stability

To determine the shelf stability of a coffee creamer, samples are stored at 7° C. for 6 months. At regular intervals (e.g., 0, 1, 3, and 6 months), the coffee creamer is evaluated for phase separation through visual inspection, droplet size distribution using NMR (measuring D3,3 with a target of 1.3-1.5 μm), pH changes using a pH meter, and viscosity using a Brookfield viscometer at 7° C. Additionally, the coffee creamer's performance is assessed by mixing it into hot coffee (85° C.-90° C., pH 4.5-5.5) and observing for curdling, separation, and sensory changes. Results are compared over time to assess stability.

### Creaming

Creaming in the context of a coffee creamer refers to the physical phenomenon where fat droplets in the emulsion rise to the surface of the liquid over time, leading to the formation of a visible layer of fat or cream on top. This occurs because fat droplets, being less dense than water, tend to migrate upwards in the emulsion if the emulsion becomes unstable. Creaming is considered undesirable because it affects the product's appearance, texture, and uniformity, and can lead to an uneven distribution of coffee creamer in coffee. The presence or absence of creaming can be determined by visual inspection and/or by measuring the droplet size distribution and layer formation over time.

### Example 1: Plant-Based Coffee Creamers

TABLE 1

| Ingredients | Ex 1 & 2 | Ex 3 | Ex 4 | C Ex 1 | C Ex 2 | C Ex 3 |
|---|---|---|---|---|---|---|
| Water | 76.36 | 76.36 | 67.46 | 76.36 | 76.36 | 76.36 |
| Canola oil | 11.5 | 11.5 | 11.5 | 11.5 | 11.5 | 11.5 |
| Sugar | 11 | 11 | 20 | 11 | 11 | 11 |
| Lentil | 0.36 | 0.36 | 0.36 | 0.36 | 0.36 | 0.36 |
| protein 55% | | | | | | |
| Salt (NaCl) | 0.05 | 0.05 | 0.05 | 0.05 | 0.05 | 0.05 |
| Dipotassium | 0.20 | 0.20 | 0.2 | — | 0.20 | 0.20 |
| phosphate | | | | | | |
| Disodium | — | — | — | 0.20 | — | — |
| phosphate | | | | | | |
| Polysorbate 60 | 0.5 | 0.5 | 0.4 | 0.5 | — | 0.5 |
| High acyl Gellan | 0.03 | — | 0.03 | 0.03 | 0.03 | — |
| gum | | | | | | |
| XG/LBG | — | 0.03 | — | — | — | — |

All powder ingredients (sugar/salts, gums, phosphates) were mixed in the aqueous phase and blended for 5 minutes at room temperature after which oil and the polysorbate were added and blended for another 5 minutes. After preheating, the product was sterilized, homogenized, cooled, filled in package and stored until further analysis.

### Results:

TABLE 2

| | | | | | C Ex | C Ex | C Ex |
|---|---|---|---|---|---|---|---|
| | Ex 1 | Ex 2 | Ex 3 | Ex 4 | 1 | 2 | 3 |
| Disodium phosphate | + | + | + | + | − | + | + |
| Polysorbate 60 | + | + | + | + | + | − | + |
| High acyl Gellan gum | + | + | + | + | + | + | − |
| High acyl Gellan gum | + | − | − | + | + | + | − |
| added at T > | | | | | | | |
| 80° C. | | | | | | | |
| XG/LBG | − | − | + | − | − | − | − |

| | | | | | C Ex | C Ex | C Ex |
|---|---|---|---|---|---|---|---|
| Results | Ex 1 | Ex 2 | Ex 3 | Ex 4 | 1 | 2 | 3 |
| Oil droplet size (μm) | 1.5 | 1.8 | 1.7 | 1.6 | 2.1 | ND* | ND** |
| Continuous phase viscosity | 30 | 30 | 30 | 46 | 26 | ND* | ND** |
| (mPA*s) at 5° C. | | | | | | | |
| Shelf life | +++ | + | + | +++ | − | ND* | ND** |
| Acidic hot application | +++ | + | + | +++ | − | ND* | ND** |
| Texture | +++ | + | + | ++++ | − | ND* | ND** |
| Creaming | No | No | No | No | Yes | ND* | ND** |
| Whitening effect | +++ | ++ | + | +++ | − | ND* | ND** |
| Off notes | No | No | No | No | No | ND* | ND** |

ND: not determinable.
Coffee creamers according to C Ex 2 were unsuitable due to unstable emulsion (lack of emulsifier).
**Coffee creamers according to C Ex 3 were unsuitable due to phase separation (no stabilizer)

Smaller water droplet sizes are preferred as this leads to increased stability of the oil-in-water emulsions and improved whitening effect.

The number of plus signs (+) corresponds to the quality of texture, with more plus signs indicating better texture quality. A single plus sign (+) indicates acceptable quality, two plus signs (++) good quality and three plus signs (+++) excellent quality.

The results indicate that the use of potassium phosphate improves the emulsion stability of the coffee creamer compared to sodium phosphate.

In hot coffee applications, the coffee creamer according to the present invention shows a good dispersion in coffee, no curdling/flocking, and an improved whitening effect.

Adding sugar (20 wt. %) to the coffee creamer provided a coffee creamer with an improved texture.

1. Plant-based, non-dairy coffee creamer comprising:
water
0.1 to 36 wt. % vegetable oil;
0.05 to 3 wt. % plant-based protein;
0.1 to 2.0 wt. % polysorbate;
0.05 to 1.0 wt. % potassium phosphate; and
0.01 to 0.5 wt. % gum, wherein the gum is high acyl gellan gum and/or a combination of xanthan gum and Locust Bean Gum (LBG)
and wherein wt. % is calculated based on the total weight of the coffee creamer.

2. Plant-based, non-dairy coffee creamer according to claim 1, wherein the gum is high acyl gellan gum.

3. Plant-based coffee creamer according to claim 1, wherein the coffee creamer does not comprise (added) mono- and diacylglycerides.

4. Plant-based coffee creamer according to claim 1, wherein the polysorbate is selected from the group consisting of polysorbate 40, polysorbate 60, polysorbate 61, polysorbate 65, polysorbate 80, and polysorbate 85; preferably the polysorbate is polysorbate 60 or polysorbate 80.

5. Plant-based coffee creamer according to claim 1, wherein the polysorbate is polysorbate 60.

6. Plant-based coffee creamer according to claim 1, wherein the coffee creamer comprises: 0.2 to 0.8 wt. % polysorbate with wt. % calculated based on the total weight of the coffee creamer.

7. Plant-based coffee creamer according to claim 1, wherein the coffee creamer comprises 0.01 to 0.1 wt. % gum, wherein wt. % is calculated based on the total weight of the coffee creamer.

8. Plant-based coffee creamer according to claim 1, wherein the coffee creamer comprises 0.01 to 0.05 wt. % gum, wherein wt. % is calculated based on the total weight of the coffee creamer.

9. Plant-based coffee creamer according to claim 1, wherein the coffee creamer comprises high acyl gellan gum as the sole gum.

10. Plant-based coffee creamer according to claim 1, wherein potassium phosphate is monopotassium phosphate, dipotassium phosphate or tripotassium phosphate; preferably potassium phosphate is dipotassium phosphate.

11. Plant-based coffee creamer according to claim 1, wherein the coffee creamer comprises 0.1 to 0.3 wt. % potassium phosphate, with wt. % calculated based on the total weight of the coffee creamer.

12. Plant-based coffee creamer according to claim 1, wherein the coffee creamer comprises 0.5 to 20 wt. % vegetable oil, preferably 7 to 15 wt. % vegetable oil with wt. % calculated based on the total weight of the coffee creamer.

13. Plant-based coffee creamer according to claim 1, wherein the coffee creamer comprises 0.1 to 0.7 wt. % plant-based protein with wt. % calculated on the total weight of the coffee creamer.

14. Plant-based coffee creamer according to claim 1, wherein the plant-based protein is selected from the group consisting of pea protein, fava protein, amaranth protein, chickpea protein, lima bean protein, and lentil protein; preferably the plant-based protein is lentil protein or pea protein.

15. Plant-based coffee creamer according to claim 1, wherein the vegetable oil is selected from the group consisting of coconut oil, rapeseed oil, linseed oil, soybean oil, maize oil, sunflower oil, and canola oil; preferably the vegetable oil is canola oil.

16. Plant-based coffee creamer according to claim 1, wherein the coffee creamer further comprises sugar, preferably 0.1 to 40 wt. % sugar, more preferably 1 to 25 wt. % sugar with wt. % calculated on the total weight of the coffee creamer.

17. Method for providing a plant-based coffee creamer according to claim 1 comprising the steps of:
providing an aqueous phase
the protein, gum and phosphate in the aqueous phase
providing an oil phase comprising polysorbate
blending the oil phase and the aqueous phase to provide the coffee creamer.

18. Method for providing a plant-based coffee creamer according to claim 17, wherein the aqueous phase is at a temperature above 70, more preferably above 75 and most preferably above 80 degrees Celsius when the gum is added.
